(19) United States
(12) Patent Application Publication
(10) Pub. No.: US 2015/0332869 A1
(43) Pub. Date: Nov. 19, 2015

(54) HIGH CAPACITY ELECTRODE FOR ELECTRIC DUAL LAYER CAPACITOR AND METHOD OF MANUFACTURING THE SAME

(71) Applicant: KOREA JCC CO., LTD., Cheongwon-gun (KR)

(72) Inventors: Dal Woo SHIN, Cheongju-si (KR); Mun Soo LEE, Cheongju-si (KR); Jin Sik SHIN, Cheongju-si (KR)

(21) Appl. No.: 14/645,738

(22) Filed: Mar. 12, 2015

(30) Foreign Application Priority Data
May 14, 2014 (KR) 10-2014-0057833
Feb. 6, 2015 (KR) 10-2015-0018625

(51) Int. Cl. H01G 11/54; B32B 7/04; B32B 37/10; B32B 18/00; B32B 37/00; B32B 3/06; B32B 15/20

(52) U.S. Cl. CPC H01G 11/54; B32B 3/06; B32B 7/045; B32B 15/20; B32B 18/00; B32B 37/0084; B32B 37/10; B32B 37/187; B32B 2250/03; C04B 2237/592; C04B 2237/363; C04B 2237/121; B32B 2307/202; B32B 2311/24; B32B 2315/02; B32B 2457/16

(57) ABSTRACT

A high capacity electrode includes a through type aluminum sheet, a plurality of first hollow protrusion members protruded to one side of the through type aluminum sheet, a plurality of second hollow protrusion members protruded to the other side of the through type aluminum sheet, a first carbon nanofiber electrode sheet bonded to the first surface of the through type aluminum sheet, and a second carbon nanofiber electrode sheet bonded to the second surface of the second surface of the through type aluminum sheet.

### CROSS-REFERENCE TO RELATED APPLICATION

This application claims the benefit of Korean Patent Application No. 10-2014-0057833, filed on May 14, 2014 and Korean Patent Application No. 10-2015-0018625, filed on Feb. 06, 2015 in the Korean Intellectual Property Office, the disclosure of which is incorporated herein by reference.

### BACKGROUND OF THE INVENTION

1. Field of the Invention

The present invention relates to a high capacity electrode for an electric double layer capacitor and a method of manufacturing the same and, more particularly, to a high capacity electrode for an electric dual layer capacitor and a method of manufacturing the same, which are capable of implementing a high capacity electrode by preventing a loss of the surface area of an aluminum sheet that is used in an electrode for an electric dual layer capacitor so that a contact area between the aluminum sheet and a carbon nanofiber electrode sheet is increased when forming a plurality of through holes in the aluminum sheet.

2. Description of the Related Art

An electric double layer capacitor (EDLC) has a less influence on the lifespan although it is repeatedly charged and discharged because it stores electric energy using a physical adsorption phenomenon with reversibility and is being applied to smart phones, hybrid vehicles, electric vehicles, and the energy storage device field applied to solar cell generation. The electric dual layer capacitor has an excellent power density, but has a low energy density. Accordingly, there is a need to develop materials for electrodes in order to improve the low energy density problem.

Korean Patent No. 1166148 (Patent Document 1) relates to a method of manufacturing an aluminum current collector having a three-dimensional pattern structure using photolithography. In the method of manufacturing the aluminum current collector disclosed in Patent Document 1, first, after an aluminum foil current collector is washed, it is dried using nitrogen atmosphere. Thereafter, a photoresist solution is coated on a surface of the dried aluminum foil current collector and then dried and cured so that the photoresist solution is selectively exposed.

Thereafter, the photoresist solution that has not been exposed is selectively removed by scattering a developer on the aluminum current collector that has been exposed so that the remaining photoresist solution is fully cured, thereby forming a pattern on the aluminum current collector. The aluminum foil current collector in which the pattern has been formed is placed between two carbon plates, that is, opposite electrodes, AC power is applied to the aluminum foil current collector, and primary etching is performed on the aluminum current collector in an electrolyte.

Thereafter, the etched aluminum current collector is dried. Next, the aluminum current collector dried after the primary etching is placed between the two carbon plates, that is, opposite electrodes, and secondary etching is performed on the aluminum current collector. Thereafter, the aluminum foil subjected to the secondary etching is washed and dried.

As in Patent Document 1, the energy density of a conventional electrode for an electric dual layer capacitor is improved by forming a pattern, that is, a plurality of through holes, in an aluminum current collector using a photolithography process so that a contact area between the aluminum current collector and graphene electrode materials is increased.

If a plurality of through holes is formed in an aluminum current collector that is used in a conventional electrode for an electric dual layer capacitor as in Patent Document 1, however, there is a problem in that the surface area of the aluminum current collector is lost by an area that belongs to a total area of the aluminum current collector and that is occupied by the through holes.

### SUMMARY OF THE INVENTION

Accordingly, the present invention has been made keeping in mind the above problems occurring in the prior art, and an object of the present invention is to provide a high capacity electrode for an electric dual layer capacitor and a method of manufacturing the same, which are capable of implementing a high capacity electrode by preventing a loss of the surface area of an aluminum sheet that is used in an electrode for an electric dual layer capacitor so that a contact area between the aluminum sheet and a carbon nanofiber electrode sheet is increased when forming a plurality of through holes in the aluminum sheet.

In an embodiment, a high capacity electrode for an electric dual layer capacitor may include a through type aluminum sheet configured to have a plurality of through holes formed in the through type aluminum sheet so that the through holes are spaced apart from one another, a plurality of first hollow protrusion members extended from the through type aluminum sheet in such a way as to communicate with the through holes and protruded to one side of the through type aluminum sheet, a plurality of second hollow protrusion members spaced apart from the plurality of first hollow protrusion members, extended from the through type aluminum sheet in such a way as to communicate with the through holes, and protruded to the other side of the through type aluminum sheet, a first carbon nanofiber electrode sheet bonded to the first surface of the through type aluminum sheet so that the plurality of first hollow protrusion members is buried, and a second carbon nanofiber electrode sheet configured to have the plurality of second hollow protrusion members buried in the second carbon nanofiber electrode sheet and bonded to the second surface of the through type aluminum sheet in such a way as to be bonded to the first carbon nanofiber electrode sheet through the plurality of first hollow protrusion members and the plurality of second hollow protrusion members.

In an embodiment, a method of manufacturing a high capacity electrode for an electric dual layer capacitor may include preparing a through type aluminum sheet configured to have a plurality of first hollow protrusion members and a plurality of second hollow protrusion members respectively formed in the first surface and second surface of the through type aluminum sheet by winding the through type aluminum sheet on a first roller, preparing a first carbon nanofiber electrode sheet by winding the first carbon nanofiber electrode sheet on a second roller, preparing a second carbon nanofiber electrode sheet by winding the second carbon nanofiber electrode sheet on a third roller, placing the first carbon nanofiber electrode sheet on the first surface of the through type aluminum sheet and the second carbon nanofiber electrode sheet on the second surface of the through type aluminum sheet, transferring the through type aluminum sheet and the first carbon nanofiber electrode sheet and the second carbon nanofiber electrode sheet to a press unit, bonding the first carbon nanofiber electrode sheet and the second carbon nanofiber electrode sheet to the first surface and second surface of the through type aluminum sheet, respectively, and simultaneously pressurizing the first carbon nanofiber electrode sheet and the second carbon nanofiber electrode sheet using the press unit so that the first carbon nanofiber electrode sheet and the second carbon nanofiber electrode sheet are connected through the plurality of first hollow protrusion members and the plurality of second hollow protrusion members.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is a cross-sectional view of a high capacity electrode which may be applied to an electric dual layer capacitor according to an embodiment of the present invention;

FIG. 2 is a cross-sectional view illustrating a state before a carbon nanofiber electrode sheet is bonded to a through type aluminum sheet of FIG. 1;

FIG. 3 is a rear view of the through type aluminum sheet of FIG. 2 which is seen from the other side;

FIG. 4 is a table illustrating various embodiments of first hollow protrusion members illustrated in FIG. 2;

FIG. 5 is a perspective view illustrating the configuration of electrode materials for the high capacity electrode which may be applied to an electric dual layer capacitor in accordance with an embodiment of the present invention;

FIG. 6 is a process flowchart illustrating a method of manufacturing the high capacity electrode, which may be applied to an electric dual layer capacitor in accordance with an embodiment of the present invention;

FIG. 7 is a process flowchart illustrating a method of manufacturing the electrode materials for the high capacity electrode, which may be applied to an electric dual layer capacitor according to an embodiment of the present invention; and

FIG. 8 is a diagram schematically illustrating the configuration of an apparatus for manufacturing the high capacity electrode, which may be applied to an electric dual layer capacitor in accordance with an embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a high capacity electrode for an electric dual layer capacitor and a method of manufacturing the same according to some embodiments of the present invention are described.

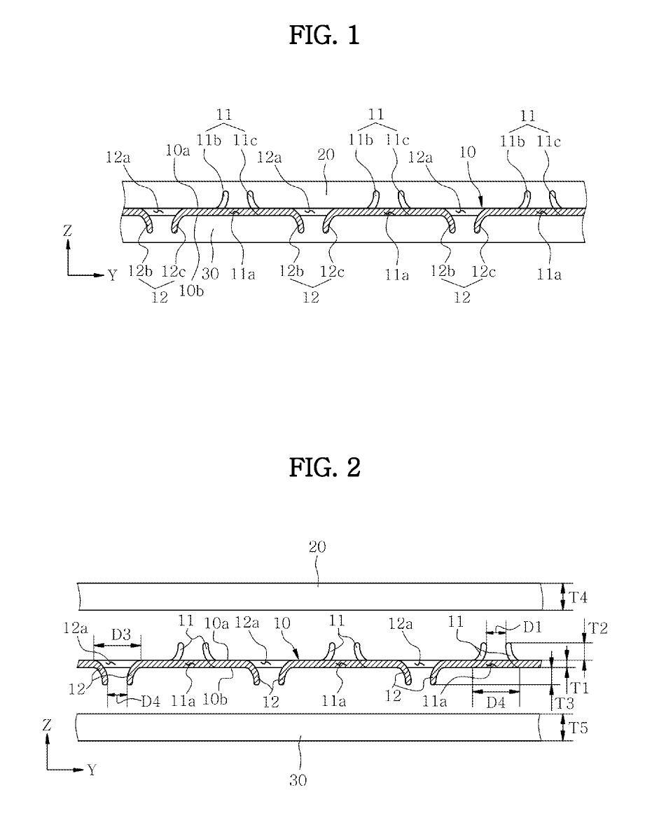

As illustrated in FIGS. 1 and 2, the high capacity electrode for an electric dual layer capacitor in accordance with an embodiment of the present invention may include a through type aluminum sheet 10, a first carbon nanofiber electrode sheet 20, and a second carbon nanofiber electrode sheet 30.

The through type aluminum sheet 10 has a plurality of through holes 11a and 12a spaced apart from one another and formed therein and includes a plurality of first hollow protrusion members 11 and a plurality of second hollow protrusion members 12. The plurality of first hollow protrusion members 11 is extended from the through type aluminum sheet 10 in such a way as to respectively communicate with the plurality of through holes 11a and is protruded to one side of the through type aluminum sheet 10. The plurality of second hollow protrusion members 12 is spaced apart from the plurality of first hollow protrusion members 11. Furthermore, the plurality of second hollow protrusion members 12 is extended from the through type aluminum sheet 10 in such a way as to respectively communicate with the through holes 12a and is protruded to the other side of the through type aluminum sheet 10. The first carbon nanofiber electrode sheet 20 is bonded to the first surface 10a of the through type aluminum sheet 10 so that the plurality of first hollow protrusion members 11 is buried. The second carbon nanofiber electrode sheet 30 is bonded to the second surface 10b of the through type aluminum sheet 10 so that the plurality of second hollow protrusion members 12 is buried and the second carbon nanofiber electrode sheet 30 is connected to the first carbon nanofiber electrode sheet 20 through the plurality of first hollow protrusion members 11 and the plurality of second hollow protrusion members 12.

The configuration of the high capacity electrode for an electric dual layer capacitor in accordance with an embodiment of the present invention is described in more detail below.

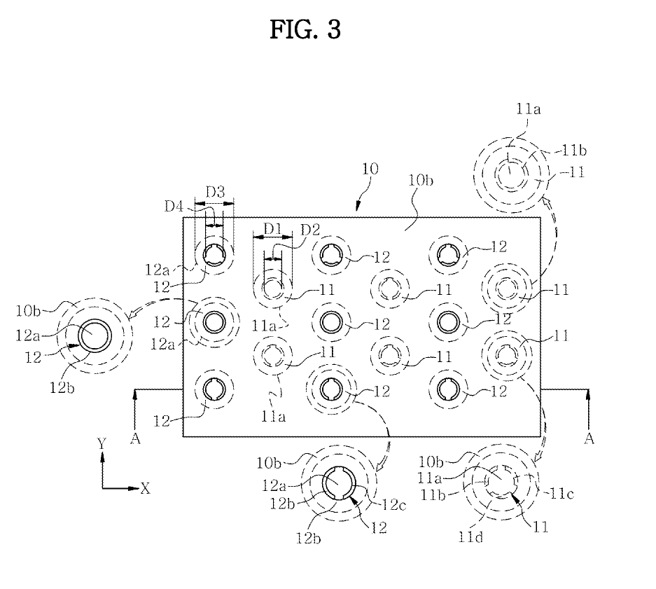

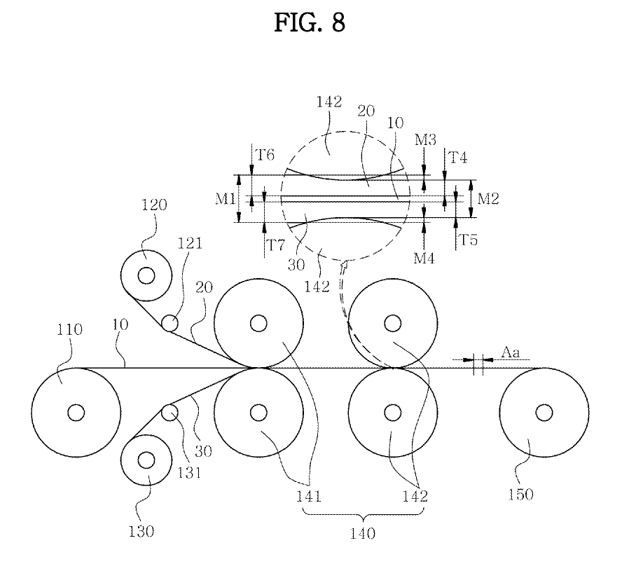

As illustrated in FIGS. 1 to 3, the through type aluminum sheet 10 includes the plurality of through holes 11a and 12a spaced apart from one another. The first surface 10a and second surface 10b of the through type aluminum sheet 10 are formed to be penetrated. Each of the diameters D1 and D3 of the respective holes 11a and 12a may be 50 to 100 μm. The through type aluminum sheet 10 in which the plurality of through holes 11a and 12a is formed may have a thickness T1 of 10 to 50 μm. The through type aluminum sheet 10 improves a specific resistance characteristic using purity of 99.20 to 99.99%, thereby improving the electrical properties of the high capacity electrode applied to an electric dual layer capacitor according to an embodiment of the present invention. In this case, FIG. 1 is an enlarged sectional view of a portion “Aa” illustrated in FIG. 8 and the through type aluminum sheet 10 of FIG. 2 is a cross-sectional view of line “A-A” illustrated in FIG. 3.

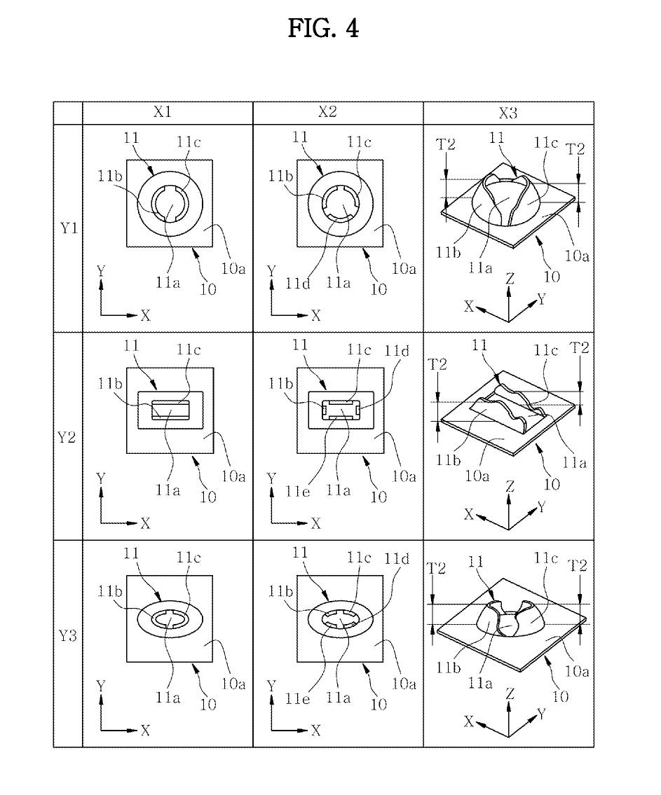

As illustrated in FIGS. 2 and 3, the plurality of through holes 11a and 12a is formed in the through type aluminum sheet 10 by perforating the through type aluminum sheet 10 using one of a cylindrical pillar member (not illustrated), an elliptical pillar member (not illustrated), and a square pillar member (not illustrated) each having a pointed tip, such as a needle or a drill, by applying pressure on the part of the first surface 10a or the second surface 10b. The plurality of first hollow protrusion members 11 and the plurality of second hollow protrusion members 12 are extended from the through type aluminum sheet 10 and protruded so that they respectively communicate with the plurality of through holes 11a and 12a. As illustrated in FIG. 4, each of the plurality of through holes 11a and 12a may have one of a cylindrical shape, an oval, and a square shape and may be formed as one of the cylindrical pillar member, the elliptical pillar member, and the square pillar member. FIG. 4 is a table illustrating various embodiments of the first hollow protrusion member 11. The second hollow protrusion member 12 is applied like the first hollow protrusion members 11 of FIG. 4, and thus a description and drawings of various embodiments of the second hollow protrusion members 12 are omitted.

For example, the plurality of first hollow protrusion members 11 may include the plurality of through holes 11a formed in the through type aluminum sheet 10 by perforating one of the cylindrical pillar member, the elliptical pillar member, and the square pillar member having a point end in the direction toward the first surface 10a of the through type aluminum sheet 10 by applying pressure. The plurality of first hollow protrusion members 11 is extended from the through holes 11a by the softness of the through type aluminum sheet 10 and protruded to one side of the through type aluminum sheet 10. In this case, the through hole 11a may have one of a cylindrical shape, an oval, and a square shape because it is formed of one of the cylindrical pillar member, the elliptical pillar member, and the square pillar member, as illustrated in FIG. 4.

Each of the plurality of through holes 11a may have one of a cylindrical shape, an oval, and a square shape because it is formed of the cylindrical pillar member, the elliptical pillar member, and the square pillar member, as illustrated in FIG. 4. For example, if the cylindrical pillar member is used, each of the plurality of through holes 11a may have a cylindrical shape as in a column Y1. If the elliptical pillar member is used, each of the plurality of through holes 11a may have an oval as in a column Y3. If the square pillar member is used, each of the plurality of through holes 11a may have a square shape as in a column Y2. The first hollow protrusion members 11 illustrated in a row X3 are perspective views of the first hollow protrusion members 11 illustrated in a row X2.

The plurality of through holes 12a of the plurality of second hollow protrusion members 12 is formed in the through type aluminum sheet 10 by perforating the through type aluminum sheet 10 in the direction toward the second surface 10b of the through type aluminum sheet 10 by applying pressure using one of the cylindrical pillar member, the elliptical pillar member, and the square pillar member each having a pointed tip. The plurality of second hollow protrusion members 12 is extended from the through holes 11a by the softness of the through type aluminum sheet 10 and protruded to the other side of the through type aluminum sheet 10. In this case, like the plurality of through holes 11a of FIG. 4, each of the plurality of through holes 12a has one of a cylindrical shape, an oval, and a square shape because it is formed of one of the cylindrical pillar member, the elliptical pillar member, and the square pillar member, as illustrated in FIG. 4.

The plurality of first hollow protrusion members 11 and the plurality of second hollow protrusion members 12 include one or more extruded burr members 11b, 11c, and 11d and 12b, 12c, and 12d because they are made of one of the cylindrical pillar member, the elliptical pillar member, and the square pillar member each having a pointed tip. For example, as illustrated in FIG. 3, the first hollow protrusion member 11 and the second hollow protrusion member 12 may include respective extruded burr members 11b and 12b or may have two or more extruded burr members 11b, 11c, and 11d and 12b, 12c, and 12d. That is, a single through type aluminum sheet 10 may include the first hollow protrusion member 11 and the second hollow protrusion member 12 that include respective extruded burr members 11b and 12b or include the two or more extruded burr members 11b, 11c, and 11d and 12b, 12c, and 12d, respectively. As in the first hollow protrusion members 11 of FIG. 4, the first hollow protrusion member 11 may include four extruded burr members 11b, 11c, 11d, and 11e if the through hole 11a is formed to have a square shape or an oval as in the column Y3 or the column Y3. The same principle applied to the first hollow protrusion members 11 may be applied to the second hollow protrusion members 12. In the table of FIG. 4, the row X1 illustrates an embodiment in which two extruded burr members 11b and 11c have been formed in the first hollow protrusion member 11. The row X2 illustrates an embodiment in which three or four extruded burr members 11b, 11c, 11d, and 11e have been formed in the first hollow protrusion member 11. The row X3 is a perspective view of the first hollow protrusion member 11 illustrated in the row X1. Furthermore, FIG. 1 is a cross-sectional view of a high capacity electrode of the electric double layer capacitor formed the first hollow protrusion members 11 and the second hollow protrusion members 12 in which the two extruded burr members 11b, 11c, and 12b, 12c illustrated in the row X1 and column Y1 of FIG. 4 have been formed.

The one or more extruded burr members 11b, 11c, and 11d and 12b, 12c, and 12d are extended from the through holes 11a and 12a and are integrally formed in the through type aluminum sheet 10 so that they are spaced apart from one another. The one or more extruded burr members 11b, 11c, and 11d and 12b, 12c, and 12d have respective heights T2 and T3 of 2 to 70 μm. For example, as illustrated in FIGS. 2 and 4, the heights T2 and T3 of the extruded burr members 11b and 12b are the highest heights from the first surface 10a of the through type aluminum sheet 10 or the second surface 10b. The plurality of extruded burr members 11b, 11c, and 11d and 12b, 12c, and 12d has been illustrated as having a height of 2 μm or more from the first surface 10a of the through type aluminum sheet 10 or the second surface 10b in the state in which they have been separated. Since the plurality of first hollow protrusion members 11 and the plurality of second hollow protrusion members 12 are formed to have the one or more extruded burr members 11b, 11c, and 11d and 12b, 12c, and 12d as described above, the surface area of the through type aluminum sheet 10 can be further increased. For example, if the first hollow protrusion member 11 and the second hollow protrusion member 12 are formed of cylindrical pillar members, the cylindrical through holes 11a and 12a having uniform diameters D1 and D3 may be formed in the first hollow protrusion member 11 and the second hollow protrusion member 12, or the extruded burr members 11b and 12b may be formed so that one sides or the other side of the first hollow protrusion member 11 and the second hollow protrusion member 12 has an inside diameter D2, D4 equal to or smaller than the diameter D1, D3. Accordingly, the surface area of the through type aluminum sheet 10 can be further increased.

The first carbon nanofiber electrode sheet 20 and the second carbon nanofiber electrode sheet 30 are simultaneously pressurized and bonded to the first surface 10a and second surface 10b of the through type aluminum sheet 10 by repeating a roll press method twice or more so that they are connected through the plurality of first hollow protrusion members 11 and the plurality of second hollow protrusion members 12 as illustrated in FIGS. 1 and 2. If the roll press method is repeatedly performed twice or more, the thicknesses T4 and T5 of the first carbon nanofiber electrode sheet 20 and the second carbon nanofiber electrode sheet 30 pressurized by the roll press method that is finally performed are 2 to 30% smaller than the thicknesses T6 and T7 (refer to FIG. 8) of the first carbon nanofiber electrode sheet 20 and the second carbon nanofiber electrode sheet 30 pressurized by the roll press method that is first performed.

As described above, the first carbon nanofiber electrode sheet 20 and the second carbon nanofiber electrode sheet 30 are simultaneously pressurized and bonded to the through type aluminum sheet 10 by repeating the roll press method twice or more. Accordingly, external appearances of the plurality of first hollow protrusion members 11 and the plurality of second hollow protrusion members 12 can be prevented from being changed or damage to the through holes 11a and 12a, such as that the through holes 11a and 12a are clogged, can be prevented due to applied pressure for bonding the first carbon nanofiber electrode sheet 20 and the second carbon nanofiber electrode sheet 30 together, and an equivalent series resistance characteristic can be prevented from being deteriorated, thereby being capable of implementing an electrode with a high capacity.

For example, the high capacity electrode for an electric dual layer capacitor in accordance with an embodiment of the present invention may be formed by repeating a roll press method twice or more using a press unit 140 illustrated in FIG. 8.

In the roll press method that is first performed, the first carbon nanofiber electrode sheet 20 and the second carbon nanofiber electrode sheet 30 are respectively bonded to the first surface 10a and second surface 10b of the through type aluminum sheet 10 by applying pressure lower than that used in the roll press method that is finally performed. That is, since the first carbon nanofiber electrode sheet 20 and the second carbon nanofiber electrode sheet 30 are bonded to the through type aluminum sheet 10 with low pressure, a change in external appearances of the plurality of first hollow protrusion members 11 and the plurality of second hollow protrusion members 12 attributable to the pressure can be prevented. As described above, in the roll press method that is first performed, the first carbon nanofiber electrode sheet 20 and the second carbon nanofiber electrode sheet 30 are partially filled in the first hollow protrusion members 11 or the second hollow protrusion members 12. As a result, a change in external appearances of the first hollow protrusion members 11 or the second hollow protrusion members 12, which may occur because pressure higher than the pressure used in the roll press method that is first performed is applied to the first hollow protrusion members 11 or the second hollow protrusion members 12, can be prevented.

If the roll press method that is second performed is a roll press method that is finally performed, in the roll press method that is finally performed, the first carbon nanofiber electrode sheet 20 and the second carbon nanofiber electrode sheet 30 are bonded to the first surface 10a and second surface 10b of the through type aluminum sheet 10 by applying pressure higher than that used in the roll press method that is first performed. In the roll press method that is finally performed, although pressure higher than that used in the roll press method that is first performed is applied, external appearances of the first hollow protrusion members 11 or the second hollow protrusion members 12 can be prevented from being changed because the first carbon nanofiber electrode sheet 20 and the second carbon nanofiber electrode sheet 30 have been partially filled in the first hollow protrusion members 11 or the second hollow protrusion members 12 to some extent. In the roll press method that is finally performed, the first carbon nanofiber electrode sheet 20 and the second carbon nanofiber electrode sheet 30 are simultaneously pressurized by applying pressure higher than that used in the roll press method that is first performed. Accordingly, the first carbon nanofiber electrode sheet 20 and the second carbon nanofiber electrode sheet 30 are filled in the plurality of through holes 11a and 12a in the state in which they have been filled in the plurality of first hollow protrusion members 11 and the plurality of second hollow protrusion members 12 and are thus connected.

By the roll press method that is finally performed, the first carbon nanofiber electrode sheet 20 and the second carbon nanofiber electrode sheet 30 are filled in the plurality of through holes 11a and 12a in the state in which they have been filled in the plurality of first hollow protrusion members 11 and the plurality of second hollow protrusion members 12 and bonded to the inner circumference surfaces or outer circumference surfaces of the plurality of first hollow protrusion members 11 and the plurality of second hollow protrusion members 12, thereby being capable of implementing the high capacity electrode. Furthermore, the deterioration of an equivalent series resistance characteristic can be prevented because a contact area between the through type aluminum sheet 10 and the first active material sheet 20 and the second active material sheet 30 is increased. The first carbon nanofiber electrode sheet 20 and the second carbon nanofiber electrode sheet 30 may be made of the same graphene electrode materials and formed by pressurizing them so that they have the thicknesses T4 and T5 reduced by 2 to 30%. Accordingly, a high capacity electrode having an improved contact property can be fabricated, and each of the thicknesses T4 and T5 may be 100 to 500 μm.

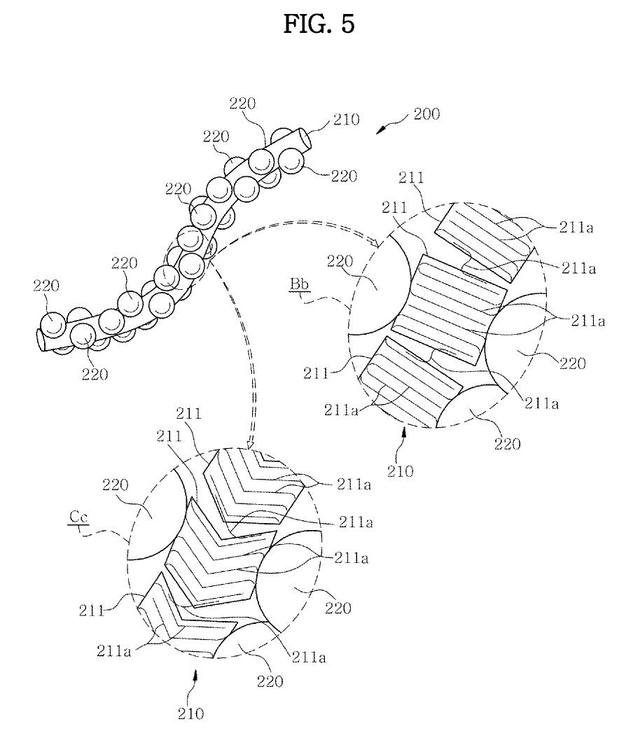

A complex graphene 200 of FIG. 5 is used as the graphene electrode materials. The complex graphene 200 is formed by mixing an exfoliated carbon nanofiber 210 and activated carbon powder 220. The activated carbon powder 220 is brought in contact and connected with the outer circumference surface of the exfoliated carbon nanofiber 210 by mixing with the exfoliated carbon nanofiber 210. As illustrated in FIG. 5, the exfoliated carbon nanofiber 210 includes one or more graphene blocks 211. Each of the one or more graphene blocks 211 includes a plurality of graphenes 211a. If the exfoliated carbon nanofiber 210 is formed of two or more graphene blocks 211, the two or more graphene blocks 211 are connected by one or more graphenes 211a. The graphene block 211 is brought in contact and connected with one or more grains of activated carbon powder 220. That is, as illustrated in FIG. 5, grains of the activated carbon powder 220 are brought in contact and connected with the end of one or more graphenes 211a that form the graphene block 211. In this case, FIG. 5 illustrates the configuration of a single exfoliated carbon nanofiber 210 formed of two or more graphene blocks 211. The graphene blocks 211 have been illustrated as being connected by a single graphene 211a.

A method of manufacturing the high capacity electrode for an electric dual layer capacitor in accordance with an embodiment of the present invention is described below with reference to the accompanying drawings.

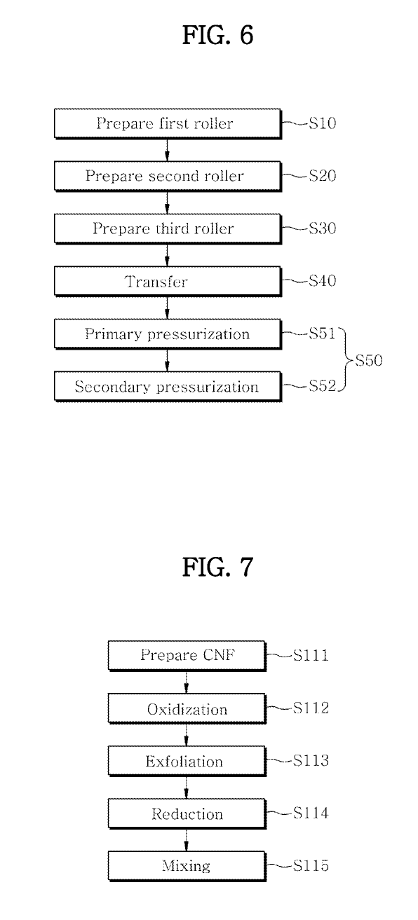

In the method of manufacturing the high capacity electrode for an electric dual layer capacitor in accordance with an embodiment of the present invention, as illustrated in FIGS. 6 and 8, first, the through type aluminum sheet 10 in which the plurality of first hollow protrusion members 11 and the plurality of second hollow protrusion members 12 have been respectively formed in the first surface 10a and second surface 10b of the through type aluminum sheet 10 is prepared by winding the through type aluminum sheet 10 on a first roller 110 at step S10. Furthermore, the first carbon nanofiber electrode sheet 20 is prepared by winding the first carbon nanofiber electrode sheet 20 on a second roller 120 at step S20, and the second carbon nanofiber electrode sheet 30 is prepared by winding the second carbon nanofiber electrode sheet 30 on a third roller 130 at step S30. When the first roller 110, the second roller 120, and the third roller 130 are prepared, the first carbon nanofiber electrode sheet 20 is placed on the first surface 10a of the through type aluminum sheet 10, the second carbon nanofiber electrode sheet 30 is placed on the second surface 10b of the through type aluminum sheet 10, and the through type aluminum sheet 10, the first carbon nanofiber electrode sheet 20, and the second carbon nanofiber electrode sheet 30 are transferred to the press unit 140 at step S40. When the through type aluminum sheet 10, the first carbon nanofiber electrode sheet 20, and the second carbon nanofiber electrode sheet 30 are transferred to the press unit 140, the first carbon nanofiber electrode sheet 20 and the second carbon nanofiber electrode sheet 30 are simultaneously pressurized by the press unit 140 so that they are respectively bonded to the first surface 10a and second surface 10b of the through type aluminum sheet 10 and they are connected through the plurality of first hollow protrusion members 11 and the plurality of second hollow protrusion members 12 at step S50. Thereafter, the results are dried through a known dry process, thereby manufacturing the high capacity electrode for an electric dual layer capacitor in accordance with an embodiment of the present invention.

At step S10 of preparing the through type aluminum sheet 10 by winding it on the first roller 110, the plurality of through holes 11a and 12a is formed in the through type aluminum sheet 10 by perforating the through type aluminum sheet 10 using one of the cylindrical pillar member (not illustrated), the elliptical pillar member (not illustrated), and the square pillar member (not illustrated) each having a pointed tip, such as a needle or a drill, by applying pressure to the first surface 10a or the second surface 10b of the through type aluminum sheet 10. Furthermore, the plurality of first hollow protrusion members 11 or the plurality of second hollow protrusion members 12 is integrally formed in the through type aluminum sheet 10 so that they are extended from the through type aluminum sheet 10 and protruded in such a way as to communicate with the plurality of through holes 11a and 12a.

The plurality of first hollow protrusion members 11 and the plurality of second hollow protrusion members 12 formed in the through type aluminum sheet 10 are protruded to one side or the other side of the through type aluminum sheet 10, that is, in a first direction or a second direction. The first direction is a direction toward the first surface 10a of the through type aluminum sheet 10. The second direction is opposite the first direction and is a direction toward the second surface 10b of the through type aluminum sheet 10.

At step S20 of preparing the first carbon nanofiber electrode sheet 20 by winding it on the second roller 120 and step S30 of preparing the second carbon nanofiber electrode sheet 30 by winding it on the third roller 130, the first carbon nanofiber electrode sheet 20 and the second carbon nanofiber electrode sheet 30 are made of the same graphene electrode materials. A viscosity control substance is mixed with the graphene electrode materials. 40 to 60 wt % of the viscosity control substance is mixed with the graphene electrode materials of 100 wt %. That is, the graphene electrode materials have viscosity of 5000 to 10000 cps (centi Poise) by mixing them with the viscosity control substance. Accordingly, the first carbon nanofiber electrode sheet 20 and the second carbon nanofiber electrode sheet 30 are transferred with some degree of viscosity and bonded to the through type aluminum sheet 10.

The complex graphene 200 of FIG. 5 is used as the graphene electrode materials. In a method of manufacturing the complex graphene 200, as illustrated in FIG. 7, first, carbon nanofibers, such as a plurality of platelet carbon nanofibers (platelet-CNFs) or a plurality of herringbone carbon nanofibers (herringbone-CNFs), are prepared at step S111. In this case, the platelet or herringbone carbon nanofibers are used as raw materials for manufacturing the exfoliated carbon nanofiber 210 and are not assigned separate reference numerals.

As illustrated in the enlarged view Bb of FIG. 5, the platelet carbon nanofibers used as the raw materials for manufacturing the exfoliated carbon nanofiber 210 is configured to have two or more graphenes 211a overlapped with the graphene block 211 in a straight form. Furthermore, as illustrated in the enlarged view Cc of FIG. 5, the herringbone carbon nanofiber is configured to have two or more graphenes 211a overlapped with the graphene block 211 in the form of the bone of a herring. After the carbon nanofiber is prepared, an expanded carbon nanofiber (not illustrated) is fabricated by oxidizing the carbon nanofiber using a Hummers method using one of KMnO₄, H₂SO₄, and H₂O₂, that is, an oxidant, at step S112. That is, a platelet carbon nanofiber or a plurality of herringbone carbon nanofibers is formed by oxidization. The graphenes 211a having a plate shape are spaced apart from each other, and thus the length thereof in the direction of a stacking axis is generally expanded.

After the platelet carbon nanofiber or the plurality of herringbone carbon nanofibers is formed into the carbon nanofiber or the expanded carbon nanofiber by oxidization, the expanded carbon nanofiber is dipped in deionized water and exfoliated in the form of one or more graphene blocks 211 by applying ultrasonic waves to the expanded carbon nanofiber, thereby fabricating the exfoliated carbon nanofiber 210 at step S113. The exfoliated carbon nanofiber 210 is partially exfoliated by applying ultrasonic waves to the expanded carbon nanofiber whose length has been partially expanded. In such partial exfoliation, the exfoliated carbon nanofiber 210 has been exfoliated in the form of one or more graphene blocks 211 as illustrated in FIG. 5.

After the exfoliated carbon nanofiber 210 is fabricated, the exfoliated carbon nanofiber 210 is reduced using hydrazine hydrate or ascorbic acid, that is, a reducing agent, at step S114. As illustrated in FIG. 5, the reduced exfoliated carbon nanofiber 210 includes one or more graphene blocks 211. Each of the one or more graphene blocks 211 includes a plurality of graphenes 211a. If a single exfoliated carbon nanofiber 210 is formed of two or more graphene blocks 211, the two or more graphene blocks 211 are connected by one or more graphenes 211a.

After the exfoliated carbon nanofiber 210 is fabricated, the complex graphene 200 is fabricated by mixing the activated carbon powder 220 with the exfoliated carbon nanofiber 210 at step S115. In the process of mixing the exfoliated carbon nanofiber 210 with the activated carbon powder 220, one or more grains of activated carbon powder 220 are brought in contact with a single graphene block 211. Accordingly, the one or more grains of activated carbon powder 220 are brought in contact and connected with the outer circumference surface of the exfoliated carbon nanofiber 210. That is, the grains of activated carbon powder 220 are brought in contact with the outer circumference surface of the exfoliated carbon nanofiber 210 and electrically connected to the exfoliated carbon nanofiber 210. The method of mixing the exfoliated carbon nanofiber 210 and with the activated carbon powder 220 is a known technology. The complex graphene 200 is fabricated by mixing the exfoliated carbon nanofiber 210 of 1 to 20 wt % with the activated carbon powder 220 of 80 to 99 wt %.

After the complex graphene 200 is fabricated, the complex graphene 200 is mixed with a viscosity control substance. The viscosity control substance includes alcohol of 30 to 60 wt % and pure water of 40 to 70 wt %. The complex graphene 200 is transferred to the press unit 140 in the state in which it has some degree of viscosity due to the viscosity control substance and bonded to the through type aluminum sheet 10. That is, the viscosity control substance is transferred to the press unit 140 in the state in which the first carbon nanofiber electrode sheet 20 and the second carbon nanofiber electrode sheet 30 have some degree of viscosity and bonded to the through type aluminum sheet 10, thereby improving adhesive strength.

At step S50 of simultaneously pressurizing the first carbon nanofiber electrode sheet 20 and the second carbon nanofiber electrode sheet 30 using the press unit 140, as illustrated in FIG. 8, first, when the first carbon nanofiber electrode sheet 20, the second carbon nanofiber electrode sheet 30, and the through type aluminum sheet 10 are transferred to a pair of first press rollers 141, the first carbon nanofiber electrode sheet 20 and the second carbon nanofiber electrode sheet 30 are primarily pressurized using the pair of first press rollers 141 with first pressure at the same time so that the first carbon nanofiber electrode sheet 20 and the second carbon nanofiber electrode sheet 30 are respectively bonded to the first surface 10a and second surface 10b of the through type aluminum sheet 10 at step S51.

When the through type aluminum sheet 10 onto which the first carbon nanofiber electrode sheet 20 and the second carbon nanofiber electrode sheet 30 have primarily pressurized is transferred to a pair of second press rollers 142, the first carbon nanofiber electrode sheet 20 and the second carbon nanofiber electrode sheet 30 that have been primarily pressurized are secondarily pressurized using the pair of second press rollers 142 with second pressure higher than the first pressure at the same time so that the first carbon nanofiber electrode sheet 20 and the second carbon nanofiber electrode sheet 30 are connected through the plurality of first hollow protrusion members 11 and the plurality of second hollow protrusion members 12 at step S52. In this case, the pressurization is performed so that the thicknesses T4 and T5 of the first carbon nanofiber electrode sheet 20 and the second carbon nanofiber electrode sheet 30 bonded to the first surface 10a and second surface 10b of the through type aluminum sheet 10 by the second pressure are 2 to 30% smaller than the thicknesses (not illustrated) of the first carbon nanofiber electrode sheet 20 and the second carbon nanofiber electrode sheet 30 bonded to the first surface 10a and second surface 10b of the through type aluminum sheet 10 by the first pressure.

As illustrated in FIG. 8, the first pressure may be set by an interval M1, that is, a separation distance between the pair of first press rollers 141, and the second pressure may be set by an interval M2, that is, a separation distance between the pair of second press rollers 142. That is, the pair of first press rollers 141 is spaced apart from each other at the interval M1 so that the first pressure is applied to the first carbon nanofiber electrode sheet 20 and the second carbon nanofiber electrode sheet 30, the first carbon nanofiber electrode sheet 20 is formed to a thickness T6, and the second carbon nanofiber electrode sheet 30 is formed to a thickness T7. Furthermore, the pair of second press rollers 142 is spaced apart from each other at the interval M2 so that the second pressure is applied to the first carbon nanofiber electrode sheet 20 and the second carbon nanofiber electrode sheet 30, the first carbon nanofiber electrode sheet 20 is formed to the thickness T4, and the second carbon nanofiber electrode sheet 30 is formed to the thickness T5. Accordingly, the thicknesses T4 and T5 of the first carbon nanofiber electrode sheet 20 and the second carbon nanofiber electrode sheet 30 become 2 to 30% smaller than the thicknesses T6 and T7. In this case, the thicknesses T6 and T7 are the same, and the thicknesses T4 and T5 are also the same.

The thicknesses T4 and T5 of the first carbon nanofiber electrode sheet 20 and the second carbon nanofiber electrode sheet 30 that have been secondarily pressurized by the second pressure so that they become 2 to 30% smaller than the thickness T6 and T7 of the first carbon nanofiber electrode sheet 20 and the second carbon nanofiber electrode sheet 30 that have been primarily pressurized by the first pressure are generated due to a difference M3+M4 between the interval M1 between the pair of first press rollers 141 and the interval M2 between the pair of second press rollers 142. That is, the first pressure and the second pressure are set by the interval M1 between the pair of first press rollers 141 of the press unit 140 and the interval M2 between the pair of second press rollers 142 of the press unit 140. A difference between the first pressure and the second pressure is generated due to the difference M3+M4 between the interval M1 between the pair of first press rollers 141 and the interval M2 between the pair of second press rollers 142. For example, if the interval M1 is set to be identical with an interval M2+M3+M4, the thicknesses T4 and T5 of the first carbon nanofiber electrode sheet 20 and the second carbon nanofiber electrode sheet 30 may become 2 to 30% smaller than the thicknesses T6 and T7, thereby easily implementing an electrode with a high capacity. In this case, the intervals M1 and M2 are respectively indicative of the interval between the pair of first press rollers 141 spaced apart from each other or the interval between the pair of second press rollers 142 spaced apart from each other.

In order to further improve adhesive strength between the through type aluminum sheet 10 and the first carbon nanofiber electrode sheet 20 and the second carbon nanofiber electrode sheet 30, conductive adhesives are used in the high capacity electrode for an electric dual layer capacitor in accordance with an embodiment of the present invention. Known materials may be used as the conductive adhesives. After the conductive adhesives are coated on the first surface 10a or second surface 10b of the through type aluminum sheet 10 in the spray state, the first carbon nanofiber electrode sheet 20 and the second carbon nanofiber electrode sheet 30 are pressurized by the press unit 140 so that the first carbon nanofiber electrode sheet 20 and the second carbon nanofiber electrode sheet 30 are more firmly bonded to the through type aluminum sheet 10 through the conductive adhesives. Accordingly, the high capacity electrode for an electric dual layer capacitor in accordance with an embodiment of the present invention is fabricated.

As described above, the high capacity electrode for an electric dual layer capacitor and the method of manufacturing the same according to the embodiments of the present invention can implement a high capacity electrode by preventing a loss of the surface area of an aluminum sheet that is used in an electrode for an electric dual layer capacitor so that a contact area between the aluminum sheet and the carbon nanofiber electrode sheet is increased when forming a plurality of through holes in the aluminum sheet.

The high capacity electrode for an electric dual layer capacitor and the method of manufacturing the same according to the embodiments of the present invention may be applied to the manufacturing industry field for electric dual layer capacitors.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A high capacity electrode for an electric dual layer capacitor, comprising:
a through type aluminum sheet configured to have a plurality of through holes formed in the through type aluminum sheet so that the through holes are spaced apart from one another;
a plurality of first hollow protrusion members extended from the through type aluminum sheet in such a way as to communicate with the through holes and protruded to a first side of the through type aluminum sheet;
a plurality of second hollow protrusion members spaced apart from the plurality of first hollow protrusion members, extended from the through type aluminum sheet in such a way as to communicate with the through holes, and protruded to a second side of the through type aluminum sheet;
a first carbon nanofiber electrode sheet bonded to a first surface of the through type aluminum sheet so that the plurality of first hollow protrusion members is buried; and
a second carbon nanofiber electrode sheet configured to have the plurality of second hollow protrusion members buried in the second carbon nanofiber electrode sheet and bonded to a second surface of the through type aluminum sheet in such a way as to be bonded to the first carbon nanofiber electrode sheet through the plurality of first hollow protrusion members and the plurality of second hollow protrusion members.

2. The high capacity electrode of claim 1, wherein:
the plurality of through holes spaced apart from one another is formed in the through type aluminum sheet,
the first surface and second surface of the through type aluminum sheet penetrate the plurality of through holes, and
each of the plurality of through holes has a diameter of 50 to 100 μm.

3. The high capacity electrode of claim 1, wherein the through type aluminum sheet has a thickness of 10 to 50 μm.

4. The high capacity electrode of claim 1, wherein:
each of the plurality of first hollow protrusion members and the plurality of second hollow protrusion members is formed by perforating the through type aluminum sheet by applying pressure on the first side or second side of the through type aluminum sheet using one of a cylindrical pillar member, an elliptical pillar member, and a square pillar member each having a pointed tip so that the plurality of through holes is formed in the through type aluminum sheet,
the plurality of first hollow protrusion members and the plurality of second hollow protrusion members are extended and protruded from the through type aluminum sheet in such a way as to respectively communicate with the plurality of through holes, and
each of the through holes has one of a cylindrical shape, an oval, and a square shape by one of the cylindrical pillar member, the elliptical pillar member, and the square pillar member.

5. The high capacity electrode of claim 1, wherein each of the plurality of first hollow protrusion members and the plurality of second hollow protrusion members comprises one or more extruded burr members formed by one of a cylindrical pillar member, an elliptical pillar member, and a square pillar member each having a pointed tip.

6. The high capacity electrode of claim 5, wherein:
the one or more extruded burr members are spaced apart from one another and integrally formed in the through type aluminum sheet so that the extruded burr members are extended from the through hole, and
each of the one or more extruded burr members has a height of 2 to 70 μm.

7. The high capacity electrode of claim 1, wherein:
the first carbon nanofiber electrode sheet and the second carbon nanofiber electrode sheet are simultaneously pressurized and bonded to the first surface and second side of the through type aluminum sheet by repeating a roll press method twice or more so that the first carbon nanofiber electrode sheet and the second carbon nanofiber electrode sheet are connected through the plurality of first hollow protrusion members and the plurality of second hollow protrusion members, and
if the roll press method is repeatedly performed twice or more, each of a thickness of the first carbon nanofiber electrode sheet and a thickness of the second carbon nanofiber electrode sheet pressurized by a roll press method that is finally performed is 2 to 30% smaller than each of a thickness of the first carbon nanofiber electrode sheet and a thickness of the second carbon nanofiber electrode sheet pressurized by a roll press method that is first performed.

8. The high capacity electrode of claim 1, wherein:
the first carbon nanofiber electrode sheet and the second carbon nanofiber electrode sheet are made of identical materials,
each of the first carbon nanofiber electrode sheet and the second carbon nanofiber electrode sheet has a thickness of 100 to 500 μm,
the materials comprise a complex graphene in which an exfoliated carbon nanofiber and activated carbon powder are mixed,
the complex graphene is formed by mixing the exfoliated carbon nanofiber with the activated carbon powder,
the activated carbon powder is brought in contact and connected to an outer circumference surface of the exfoliated carbon nanofiber,
the exfoliated carbon nanofiber comprises one or more graphene blocks,
each of the one or more graphene blocks comprises a plurality of graphenes,
if the exfoliated carbon nanofiber comprises two or more graphene blocks, the two or more graphene blocks are connected by one or more graphenes, and
one or more grains of the activated carbon powder are brought in contact and connected with the graphene block.

9. A method of manufacturing a high capacity electrode for an electric dual layer capacitor, the method comprising:
preparing a through type aluminum sheet configured to have a plurality of first hollow protrusion members and a plurality of second hollow protrusion members respectively formed in a first surface and second surface of the through type aluminum sheet by winding the through type aluminum sheet on a first roller;
preparing a first carbon nanofiber electrode sheet by winding the first carbon nanofiber electrode sheet on a second roller;
preparing a second carbon nanofiber electrode sheet by winding the second carbon nanofiber electrode sheet on a third roller;
placing the first carbon nanofiber electrode sheet on the first surface of the through type aluminum sheet and the second carbon nanofiber electrode sheet on the second surface of the through type aluminum sheet and transferring the through type aluminum sheet and the first carbon nanofiber electrode sheet and the second carbon nanofiber electrode sheet to a press unit; and
bonding the first carbon nanofiber electrode sheet and the second carbon nanofiber electrode sheet to the first surface and second surface of the through type aluminum sheet, respectively, and simultaneously pressurizing the first carbon nanofiber electrode sheet and the second carbon nanofiber electrode sheet using the press unit so that the first carbon nanofiber electrode sheet and the second carbon nanofiber electrode sheet are connected through the plurality of first hollow protrusion members and the plurality of second hollow protrusion members.

10. The method of claim 9, wherein preparing the through type aluminum sheet comprises:
forming a plurality of through holes in the through type aluminum sheet by perforating the through type aluminum sheet by applying pressure in the first surface or the second surface using one of a cylindrical pillar member, an elliptical pillar member, and a square pillar member each having a pointed tip, and
integrally forming the plurality of first hollow protrusion members or the plurality of second hollow protrusion members so that the plurality of first hollow protrusion members or the plurality of second hollow protrusion members are extended and protruded from the through type aluminum sheet in such a way as to respectively communicate with the plurality of through holes.

11. The method of claim 10, wherein each of the plurality of first hollow protrusion members and the plurality of second hollow protrusion members is protruded to a first side or second side of the through type aluminum sheet.

12. The method of claim 9, wherein in preparing the first carbon nanofiber electrode sheet by winding the first carbon nanofiber electrode sheet on the second roller and preparing the second carbon nanofiber electrode sheet by winding the second carbon nanofiber electrode sheet on the third roller, the first carbon nanofiber electrode sheet and the second carbon nanofiber electrode sheet are made of identical graphene electrode materials, the graphene electrode materials are mixed with a viscosity control substance, and the viscosity control substance of 40 to 60 wt % is mixed with the graphene electrode materials of 100 wt % so that the graphene electrode materials have viscosity of 5000 to 10000 cps (centi Poise).

13. The method of claim 12, wherein:
the graphene electrode materials comprise a complex graphene,
the complex graphene is fabricated by:
preparing a carbon nanofiber;
fabricating an expanded carbon nanofiber by oxidizing the carbon nanofiber using a hummers method using one of oxidants comprising KMnO₄, H₂SO₄, and H₂O₂;
dipping the expanded carbon nanofiber in deionized water exfoliating the expanded carbon nanofiber in a form of one or more graphene blocks by applying ultrasonic waves to the one or more graphene blocks in order to obtain the exfoliated carbon nanofiber;
reducing the exfoliated carbon nanofiber using a reducing agent comprising hydrazine hydrate or ascorbic acid after fabricating the exfoliated carbon nanofiber; and
fabricating the complex graphene by mixing activated carbon powder with the exfoliated carbon nanofiber after reducing the exfoliated carbon nanofiber,
wherein in preparing the carbon nanofiber, the carbon nanofiber comprises a plurality of platelet carbon nanofibers (platelet-CNFs) or a plurality of herringbone carbon nanofibers (herringbone-CNFs); in fabricating the exfoliated carbon nanofiber, a single exfoliated carbon nanofiber comprises one or more graphene blocks each comprising a plurality of graphenes; if the exfoliated carbon nanofiber comprises two or more graphene blocks, the two or more graphene blocks are connected by one or more graphenes; and in fabricating the complex graphene by mixing activated carbon powder with the exfoliated carbon nanofiber, one or more grains of activated carbon powder are brought in contact with a single graphene block so that the one or more grains of activated carbon powder are brought in contact and connected with an outer circumference surface of the exfoliated carbon nanofiber.

14. The method of claim 12, wherein the viscosity control substance comprises alcohol of 30 to 60 wt % and pure water of 40 to 70 wt %.

15. The method of claim 9, wherein simultaneously pressurizing the first carbon nanofiber electrode sheet and the second carbon nanofiber electrode sheet using the press unit comprises:
primarily pressurizing the first carbon nanofiber electrode sheet and the second carbon nanofiber electrode sheet with first pressure using a pair of first press rollers so that the first carbon nanofiber electrode sheet and the second carbon nanofiber electrode sheet are respectively bonded to the first surface and second surface of the through type aluminum sheet; and
secondarily pressurizing the first carbon nanofiber electrode sheet and the second carbon nanofiber electrode sheet simultaneously with second pressure higher than the first pressure using a pair of second press rollers so that the primarily pressurized first carbon nanofiber electrode sheet and second carbon nanofiber electrode sheet are connected through the plurality of first hollow protrusion members and the plurality of second hollow protrusion members,
wherein the first pressure is set by an interval between the pair of first press rollers, and the second pressure is set by an interval between the pair of second press rollers.

16. The method of claim 15, wherein in secondarily pressurizing the first carbon nanofiber electrode sheet and the second carbon nanofiber electrode sheet, the second pressure is applied so that thicknesses of the first carbon nanofiber electrode sheet and the second carbon nanofiber electrode sheet bonded to the first surface and second surface of the through type aluminum sheet are 2 to 30% smaller than thicknesses of the first carbon nanofiber electrode sheet and the second carbon nanofiber electrode sheet bonded to the first surface and second surface of the through type aluminum sheet by the first pressure.
